(19) United States
(12) Patent Application Publication
(10) Pub. No.: US 2009/0051489 A1
(43) Pub. Date: Feb. 26, 2009

(54) SECURITY SYSTEM AND METHOD BY IRIS KEY SYSTEM FOR DOOR LOCK

(76) Inventor: Shinho Kim, Kyeungido (KR)

Correspondence Address: CANTOR COLBURN, LLP, 20 Church Street, 22nd Floor, Hartford, CT, 06103, US

(21) Appl. No.: 11/577,440

(22) PCT Filed: Oct. 17, 2005
(86) PCT No.: PCT/KR05/03455

§ 371 Date: Apr. 18, 2007

(30) Foreign Application Priority Data
Oct. 18, 2004 (KR) 10-2004-0083326

(51) Int. Cl. G06F 7/04

(52) U.S. Cl. 340/5.82

(57) ABSTRACT

A security system and method using an iris key system for a door lock are disclosed, in which an inherent iris key code is stored in a static memory of an iris key unit, and an iris key code is copied and recorded into a temporary memory only when an iris verification result of an iris security drive unit corresponds to a verified user. In addition, when it is judged that an iris key code stored in a door opening and closing unit is matched with an iris key code of the temporary memory by a door controller of a door opening and closing unit, an operation of a door opening and closing unit is automatically allowed, so that it is possible to prevent a non-verified door opening and closing operation.

### TECHNICAL FIELD

The present invention relates to a security system and method by an iris key system for a door lock, and in particular to a security system and method using an iris key system for a door lock in which an inherent iris key code is stored in a static memory of an iris key unit, and an iris key code is copied and recorded into a temporary memory only when an iris verification result of an iris security drive unit corresponds to a verified user. In addition, when it is judged that an iris key code stored in a door opening and closing unit is matched with an iris key code of the temporary memory by a door controller of a door opening and closing unit, an operation of a door opening and closing unit is automatically allowed, so that it is possible to prevent a non-verified door opening and closing operation.

### BACKGROUND ART

Various security systems and methods have been developed so as to prevent international terrors, social crimes and non-verified invasions and have been applied to various fields. The functions of the above systems and methods have been fast enhanced.

As a limited method of an entrance and exit control, there are a security key system using an ordinary key, a password or a PIN, and a biometrics security system in which an entrance is permitted only after a one's identification is verified using a user's biometrics information.

The security system using a biometrics information is directed to an excellent one's identification verification method using an inherent characteristic of a certain part of a living human body which is different from others. As a representative one of the biometrics recognition system, there is a fingerprint recognition system which uses a one's fingerprint characteristic and has been used as a security method in many fields. Except for the above systems and methods, there is further provided a security method using an iris characteristic. The iris security system uses an inherent characteristic that a sign phase of a surface of an iris has a pattern, which is fixed at about 3 years, and the above characteristic never changes throughout one's life.

### DISCLOSURE OF INVENTION

### Technical Problem

The conventional iris security system is an integral type which cannot be divided into a door opening and closing unit and an iris security system and includes a zoom function (zoom in and out), a PAN function (left and light rotations), and a TILT function (up and down movements). In this case, the iris security system as a conventional biometrics system is very complicated in its construction, and the standards of the systems are different. In addition, the fabrication unit cost and its sale price are expensive, resulting in a rare application to the ordinary door security system.

Therefore, as a measurement for the conventional door opening and closing apparatus, a low cost, stable and high level security system is urgently needed in the field.

### Technical Solution

Accordingly, it is an object of the present invention to provide a security system and method using an iris key system for a door lock which overcomes the problems encountered in the conventional art.

It is another object of the present invention to provide a security system and method using an iris key system for a door lock in which an apparatus for verifying a user when using a door opening and closing apparatus is provided with a portable iris security unit being separable from a door opening and closing unit, so that a low cost and stable security system can be constructed.

### ADVANTAGEOUS EFFECTS

According to the security system and method using an iris key system for a door lock according to the present invention, an iris key code is stored in a static memory of a security key unit 200. When an iris verification result of the iris security drive unit is matched with a verified user, the iris key code is copied and recorded in a temporary memory. Continuously, an operation of a door opening and closing unit is permitted only when an ills key code previously stored by a door controller of a door opening and closing unit is matched with an ills key code of the temporary memory, so that a high level security effect with respect to a non-verified opening and closing trial can be obtained, and a low cost and stable security system can be achieved.

### BRIEF DESCRIPTION OF THE DRAWINGS

FIG. 1 is a block diagram illustrating an iris key system for a door security according to the present invention.

FIG. 2 is a block diagram illustrating an iris key unit of an iris key system for a door security according to the present invention.

FIG. 3 is a conception view illustrating an application of an iris key system for a door security according to the present invention.

FIG. 4 is a flow chart of a door security method of an iris key unit according to the present invention.

FIG. 5 is a flow chart of a door security method of a door opening and closing unit according to the present invention.

### MODE FOR THE INVENTION

In a security system for a door opening and closing using an iris verification characteristic, there is provided an iris key system for a door security, comprising a portable iris key unit 200 which includes an iris key code static memory 230 formed of a connection plug detachable from a door opening and closing unit 100 and statically storing an iris key code; an iris key code temporary memory 210 for temporarily storing an his key code therein; and an his driving element 220 which is formed of a DSP processor, a camera and an iris security program and copies an iris key code of the his key code static memory 230 only when the previously stored original iris code is matched with an iris code of the his image inputted during a verification and stores into the iris key code temporary memory 210; and a door opening and closing unit 100 which includes a door opening and closing element 130 formed of a connection socket detachable from the iris key unit 200 for thereby driving an opening and closing of the door; an his key code DB 120 for previously storing iris key codes therein for a recognition of a corresponding iris key unit 200; and a door controller 110 which receives an his key code stored in the iris key code temporary memory 210 of the inserted iris key unit 200 during an operation of the door opening and closing element 130, compares the received iris key code with the iris key code previously stored in the iris key code DB 120 and permits an operation of the door opening and closing element 130 only when the compared iris key codes are matched with each other.

In addition, in a security method of a door using an his key, there is provided an iris key security method, comprising a step (1) in which an iris key unit 200 previously stores an original iris code, generates a reference iris code based on an iris image and compares the generated reference iris code with the stored original iris code; a step (2) in which the iris key code statically stored in the iris key code static memory 230 into the iris key code temporary memory 210 only when a result of the verification corresponds to a verified user; a step (3) in which a connection plug of the iris key unit 200 is inserted into a connection socket of the door opening and closing unit 100; a step (4) in which an his key code stored in the his key code temporary memory 210 of the iris key unit 200 is compared with an iris key code previously stored in the iris key code DB 120 of the door opening and closing unit 100 so as to judge whether the iris key unit 200 inserted into the connection socket of the door opening and closing unit 100 is a verified key; and a fifth step (5) in which an operation of the door opening and closing element 130 is permitted only when the iris key codes are matched with each other in the fourth step.

The preferred embodiment of the present invention will be described with reference to the accompanying drawings.

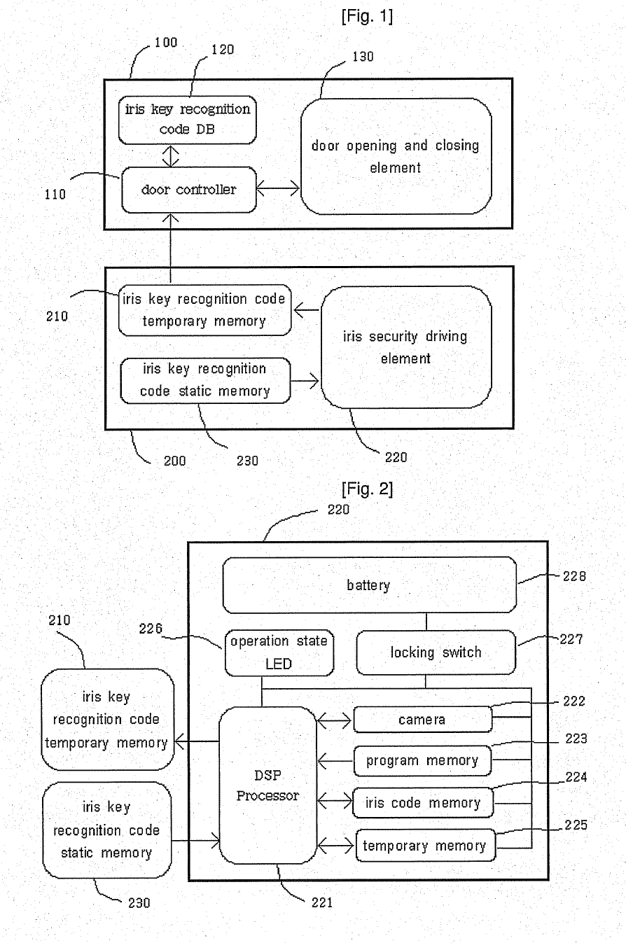

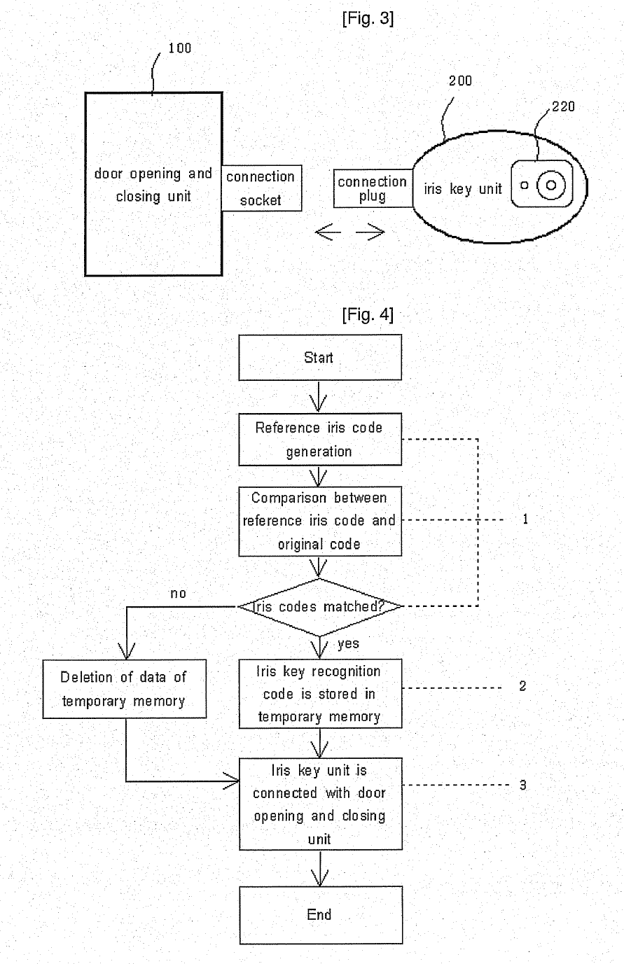

FIG. 1 is a block diagram illustrating an iris key system for a door security according to the present invention, and FIG. 2 is a block diagram illustrating an iris key unit of an iris key system for a door security according to the present invention, and FIG. 3 is a conception view illustrating an application of an iris key system for a door security according to the present invention.

As shown in FIGS. 1 through 3, the iris key system for a door security according to the present invention comprises a door opening and closing unit 100, and an iris key unit 200.

The door opening and closing unit 100 includes a door opening and closing element 130 for enabling an opening and closing of the door, a door control element 110 for determining an opening and closing state of the door opening and closing element 130, and an iris key code DB 120 for storing iris key codes. Here, the iris key code DB 120 corresponds to a database which stores inherent iris key codes allocated to the iris key unit 200. The database corresponds to a plurality of iris key elements as a plurality of iris key codes are stored therein based on each iris key unit. When the door opening and closing element 130 operates, the door controller 110 compares the iris key code DB 120 with the iris key code recorded in the iris key code temporary memory 210 of the iris key storing unit 200 so as to recognize whether the inserted and connected iris key unit 200 is a verified key.

Here, the iris key unit 200 is a portable key, which is separated from the door opening and closing unit 100 and is portable. With the iris key unit 200, the user is verified in a state that it is separated from the door opening and closing unit 100.

Continuously, the iris key unit 200 includes an iris security driving element 220 which determines a verified use based on an iris verification, an iris key code static memory 230 which statically stores iris key codes, and an iris key code temporary memory 210 which temporarily stores iris key codes when the iris is verified. Here, the iris key code static member is formed of a certain memory device such as a non-volatile ROM. The iris key code temporary memory is formed of a certain memory device such as a volatile RAM.

As shown in FIG. 2, the iris security driving element 220 includes an iris code memory 224 for storing an original iris code, a camera 222 for photographing an iris image, a program memory 223 which has an iris security algorithm for judging a matching state between an iris code generated by capturing an iris image and an original ins code, a DSP processor 221 for executing and controlling the ins security algorithm, an operation state display LED 226 for displaying an operation state of the iris key storing unit 200, a secondary battery 228 for supplying an electric power to the elements of the iris key unit 200, and a locking switch 227 for selectively locking or unlocking the ins security driving element 220.

The operations of the iris key system for a door security according to the present invention will be described with reference to FIGS. 1 through 3.

First, in a state that the iris key unit 200 is separated from the door opening and closing unit 100, when a verifier positions the lock switch 227 of the iris security driving element 220 of the iris key unit 200 at the lock state and then positions the same at the unlock state, electric power is supplied to the elements including the ins security driving element 220, and the DSP processor 221 of the iris security driving element 220 loads an ins security program from the program memory 223 and executes the loaded program. With the above operation, the iris security driving element 220 is in the verification standby state, and the operation state display LED 226 turns on the yellow color.

In the case that the original iris code is not stored in the ins code memory 224, the iris security program operates in the registration mode in the verification standby state. When the original ins code is present, it operates in the verification mode.

When the verifier allows his iris to be close to the camera 222, the iris security program of the DSP processor 221 captures an ins image and generates an iris code. At this time, in the registration mode, the generated iris code is recorded into the iris code memory 224 as an original iris code. In the case of the verification mode, the generated iris code is compared with the original iris code of the iris code memory 224. As a result of the comparison, when the results are matched with each other, the iris key code stored in the iris key code static memory 230 is copied and stored into the iris key code temporary memory 210. At this time, the operation state LED 226 turns on the green color.

When the user inserts the connection plug of the iris key unit 200 into the connection socket of the door opening and closing unit 100, the door controller 110 of the door opening and closing unit 100 compares the iris key code previously stored in the iris key code DB 120 with the iris key code stored in the iris key code temporary memory 210 of the iris key unit 200. As a result of the comparison, when the codes are matched with each other, the operation of the door opening and closing element 130 is permitted.

When the original iris code is not matched with the generated iris code during the iris verification in the iris key unit 200, the iris security program of the iris security driving element 220 deletes the data of the iris key code temporary memory 210. Therefore, even when the ins key unit 200 is connected with the door opening and closing unit 100, since the door controller 110 of the door opening and closing unit 100 fails to search a corresponding ins key code from the iris key code temporary memory 210 of the inserted ins key unit 200, the access to the door opening and closing element 120 is not permitted. In this case, the door opening and closing element remains in the protection state with respect to a non-verified opening and closing trial of the door opening and closing unit.

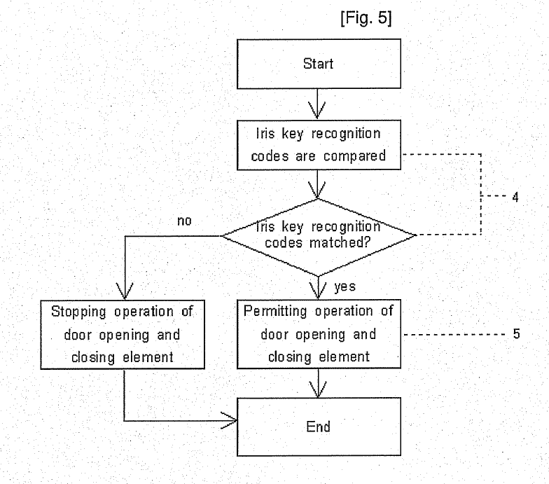

The security method of the door opening and closing by the iris security key unit will be described with reference to FIGS. 4 and 5.

FIG. 4 is a flow chart of a door security method of an iris key unit according to the present invention.

FIG. 5 is a flow chart of a door security method of a door opening and closing unit according to the present invention.

The verifier is basically processed with a verification procedure of the iris key unit 200. The iris key unit 200 is inserted into the door opening and closing unit 100. The door opening and closing unit 100 compares the previously stored iris key code with the ins key code of the inserted ins key unit 200. The use of the door opening and closing element 120 is permitted or not permitted based on a result of the comparison.

In a first step, when the iris security driving element 220 of the iris key unit 200 drives the ins security program, the verifier allows his iris to be close to the is photographing camera, and the iris program receives the ins images and generates a reference iris code and compares the previously stored original iris code with the reference iris code.

In a second step, as a result of the comparison, when it is judged that the codes are matched with each other in the first step, the iris key code is copied from the iris key code static memory 230 and is stored in the iris key code temporary memory 210. When the codes are not matched with each other, the data of the ins key code temporary memory 210 are deleted.

Continuously, in a third step, the connection plug of the iris key unit 200 is inserted into the connection socket of the door opening and closing unit 100.

In a fourth step, in the door opening and closing unit 100, when the iris key unit 200 is inserted and connected, the door controller 110 compares the iris key code previously stored in the iris key code DB 120 with the iris key code of the iris key code temporary memory 210 of the inserted iris key unit 200.

In a fifth step, the door controller 110 of the door opening and closing unit 100 permits or does not permits the operation of the door opening and closing element 130 based on a result of the comparison between the iris key codes.

### INDUSTRIAL APPLICABILITY

In the present invention, an iris key code is stored in a static memory of a security key unit 200. When an iris verification result of the iris security drive unit is matched with a verified user, the iris key code is copied and recorded in a temporary memory. Continuously, an operation of a door opening and closing unit is permitted only when an iris key code previously stored by a door controller of a door opening and closing unit is matched with an iris key code of the temporary memory, so that a high level security effect with respect to a non-verified opening and closing trial can be obtained, and a low cost and stable security system can be achieved.

### SEQUENCE LISTING

iris key, door lock, iris security system, iris code

1. In a security system for a door opening and closing using an iris verification characteristic, an ills key system for a door security, comprising:
a portable iris key unit 200 which includes:
an iris key code static memory 230 formed of a connection plug detachable from a door opening and closing unit 100 and statically storing an his key code;
an ins key code temporary memory 210 for temporarily storing an his key code therein; and
an iris driving element 220 which is formed of a DSP processor, a camera and an iris security program and copies an iris key code of the iris key code static memory 230 only when the previously stored original iris code is matched with an iris code of the iris image inputted during a verification and stores into the iris key code temporary memory 210; and
a door opening and closing unit 100 which includes:
a door opening and closing element 130 formed of a connection socket detachable from the iris key unit 200 for thereby driving an opening and closing of the door;
an iris key code DB 120 for previously storing his key codes therein for a recognition of a corresponding iris key unit 200; and
a door controller 110 which receives an ins key code stored in the his key code temporary memory 210 of the inserted iris key unit 200 during an operation of the door opening and closing element 130, compares the received iris key code with the his key code previously stored in the iris key code DB 120 and permits an operation of the door opening and closing element 130 only when the compared iris key codes are matched with each other.

2. The system of claim 1, wherein said iris key unit 200 is detachable from a connection socket of the door opening and closing unit 100 through a connection plug.

3. The system of claim 1, wherein the connection plug of the iris key unit 200 and the connection socket of the door opening and closing unit 100 are formed of a transmitter and a receiver, respectively, and are connected based on a wireless communication method.

4. The system of claim 1, wherein said iris key code DB 120 of the door opening and closing apparatus 100 is formed of a database which stores a plurality of iris key codes corresponding to each iris key unit 200.

5. The system of claim 1, wherein said iris security driving element 220 includes:
an iris code memory device 224 for storing an original iris code;
a program memory device 223 having an iris security code which judges whether an iris code generated by capturing an iris image using an iris photographing camera 222 during a verification is matched with the original iris code or not, copies an iris key code of the iris key code static memory 230 based on the matching state and determines whether the copied iris key code is stored into the iris key code temporary memory 210 or not;
a DSP processor 221 which executes and controls the iris security program of the program memory device;
a temporary memory (RAM) 225 which is used by the DSP processor;
an iris image photographing camera 222 which transmits an iris image to the DSP processor;
an operation state display LED 226 which displays an operation state of the iris key unit 200 based on an iris verification state;
a secondary battery 228 which is chargeable and supplies an electric power to the elements of the iris key unit 200 including the DSP processor 221; and
a locking switch 227 which applies an electric power from the battery 228 to the iris security driving element 220 and selectively locks or unlocks the iris security apparatus 220.

6. In a security method of a door using an iris key, an iris key security method, comprising:
a step (1) in which an iris key unit 200 previously stores an original ills code, generates a reference iris code based on an iris image and compares the generated reference iris code with the stored original iris code;
a step (2) in which the iris key code statically stored in the iris key code static memory 230 into the iris key code temporary memory 210 only when a result of the verification corresponds to a verified user;
a step (3) in which a connection plug of the ills key unit 200 is inserted into a connection socket of the door opening and closing unit 100;
a step (4) in which an iris key code stored in the iris key code temporary memory 210 of the iris key unit 200 is compared with an iris key code previously stored in the iris key code DB 120 of the door opening and closing unit 100 so as to judge whether the iris key unit 200 inserted into the connection socket of the door opening and closing unit 100 is a verified key; and
a fifth step (5) in which an operation of the door opening and closing element 130 is permitted only when the iris key codes are matched with each other in the fourth step.
